(19) United States
(12) Patent Application Publication
(10) Pub. No.: US 2016/0001131 A1
(43) Pub. Date: Jan. 7, 2016

(54) Accurate Step Counting Pedometer for Children, Adults and Elderly

(71) Applicants: Katarzyna Radecka, Verdun (CA); Zeljko Zilic, Verdun (CA)

(72) Inventors: Katarzyna Radecka, Verdun (CA); Zeljko Zilic, Verdun (CA)

(21) Appl. No.: 14/324,055

(22) Filed: Jul. 3, 2014

(51) Int. Cl. A63B 24/00; G01C 22/00

(52) U.S. Cl. CPC A63B 24/0062; G01C 22/006

(57) ABSTRACT

The present invention related to the area of lifestyle devices, particularly to pedometers used for exercise tracking. This invention aims at accurate recording of steps, speeds, distances, type of motion (walk and run) and calories expenditure, independently of the personal characteristics (age, gender, weight and height). The invention uses sub-band decomposition filters that produce non-distorted sine wave regardless of personal traits and the type of walking or running. Low-complexity zero-crossing step detection is subsequently applied, and the step length and energy expenditure information is then extracted. The method for goals tracking is included for independent types of goals: steps, energy, distance and duration.

### FIELD OF THE INVENTION

This invention relates to the area of lifestyle devices (pedometers) used for continuous monitoring of exercise activities such as walking and running with real-time reporting of steps, type of exercise, speed and distance.

### BACKGROUND OF THE INVENTION

Maintaining an active lifestyle is critical to health and wellness regardless of age. Typical daily physical activities comprise habitual actions and different levels of organized exercise routines. The recommended level of exercises depends on age and gender [1], [2]. However, due to the versatility of daily activities, and the inability of humans to accurately track them, the only way to have a full picture of a scope of daily activities is through portable fitness tracking devices.

Presently the best ways to measure the intensity and duration of daily activities are by means of pedometers, which should be equally accurate for all users regardless of their age, gender and weight.

Together with personal characteristics (weight, height, age, gender), the duration and the speed of the movement contribute to expending the energy by humans. Therefore, a pedometer should account accurately for: step count, type of movement, speed, distance, and energy consumed. Among numerous pedometer devices, it has been noted that their accuracy depends on personal characteristics (weight, height, age, gender) as well as the speed of motion, and therefore overweight persons and children often report inaccurate pedometer readings [1], [2].

The accuracy of reported results needs to be stressed, as the pedometer inaccuracies can merely be tolerated if these devices are used only for trend indications. However, for healthcare applications the accuracy of the pedometers is of primary concern. Diabetes is one such ailment, where daily exercises are known to improve blood glucose control, but improperly managed level of exercise can have serious consequences. Therefore, the main goal of the proposed multifunctional pedometer is to provide, within 2% of accuracy, an estimate of step count, distance and speed for walking and running in the speed ranges: 1, 2, 3 and 4 mph (walk), and 5, 6, 7, 8, 9 and 10 mph (run). The pedometer also works with the metric system for the corresponding speeds. The proposed pedometer is designed to work equally well for children, adults, elderly, overweighed and obese individuals.

Finally, due to the accurate reporting of steps, speed and distance of the exercise, this pedometer can be used by professional athletes to improve their training routines.

Algorithms for accelerometer-based pedometers can be implemented either as stand-alone devices or as a software applications running on the portable devices such as smart phones. In either realization, the battery life is a critical factor. Therefore, it is highly desired that the step detection, as well as motion and speed classification algorithms are energy- and computationally efficient. Due to the simplicity of the algorithmic solutions, which require a modest amount of computing operations, the proposed pedometer is energy efficient.

Steps detection algorithms aim to accurately report the number of steps taken regardless of personal traits and the type of the movement. The speed of the movement is then derived as a number of steps multiplied by the step length, divided by the duration. The distance depends on the step count and step length. The step length is a function of personal traits and a type of the movement (running/walking, etc.).

Energy expenditure algorithms intend to accurately account for the calories burned during the physical activity. A number of mappings between the duration of a given type of activity and the energy expended have been developed, such as the 2012 Compendium of Physical Activities (CPA) [3]. For a wide range of human activities, CPA tabulates the Metabolic Equivalent of Task (MET), which is the ratio of energy cost of a physical activity and the reference metabolic rate.

The Basal Metabolic Rate (BMR) is the rate of energy expenditure by humans at rest. The BMR can be calculated using, for example, the Revised Harris-Benedict equation [4] as a function of gender, weight, height and age.

The energy expenditure for the given physical activity is obtained by multiplying MET, BMR and the duration of the activity. For energy expenditure of the physical activities expressed in kcal the following equation can be used for exercise duration given in minutes:

Energy Expended=MET*(BMR/1440)*duration[min] (Eq. 1)

### BRIEF SUMMARY OF THE INVENTION

This invention presents methods for tracking step count, distance, type of exercise (walk and run), speed and energy consumption during physical activities. Our solution comprises a range of algorithms for step length determination (personalized for users based on their age, gender, weight and height), step count, movement classification (walk or run), speed and distance estimation and energy consumption.

The proposed pedometer is capable of uninterrupted daily activity tracking. Furthermore, the motion data processed by the proposed algorithms allows the user on setting a variety of complex exercise goals. In particular, this solution supports the following goals: step count executed with selected speed and type of motion; distance achieved with selected speed and type of motion, energy expenditure (exercise caloric balance); or duration of exercise. The goal can be also set as a composition of sub-goals active in the time intervals. The goal is reached either when the user-set goal plan is realized, or when the energy expenditure of the goal algorithmically determined is met.

The proposed pedometer algorithms work with the signal coming from one or three orthogonal accelerometers capturing the user's motion characteristics. The accelerometer signal is subjected to the sub-band filter analysis, where a filter bank is used to decompose the accelerometer signal into frequency sub-bands representing different speeds and type of motion. The filter bank for the sub-band decomposition eliminates the distortions of the acceleration signal, and grants a non-distorted sine wave signal capturing the motion of the user. The output of the filter bank can be then easily processed to obtain the step count, distance, speed and type of motion.

Further, the computational cost of the algorithms is restricted to limited number of cycles per second, making the proposed pedometer a plausible application to run in the background on portable devices, without interrupting other processes executed concurrently on these devices.

At the same time, the proposed pedometer algorithms are within 2% accuracy in determining the step count, type of the exercise (walk or run), speed of motion and distance. The results are not compromised by user's age and weight and, hence, the pedometer can be worn successfully by all the age groups from children to elderly as well as overweight and obese individuals.

### BRIEF DESCRIPTION OF THE DRAWINGS

FIG. 1 contains block diagrams of the step detection algorithm.

FIG. 2 shows two cases of accelerometer signals capturing walking and running exercises, as well as the same signals post-processed by proposed filter bank.

FIG. 3 illustrated the frame structure.

FIG. 4 shows the diagram of steps per second reported for a sample treadmill exercise of walking and running with varying set of speeds.

FIG. 5 shows which goal features are algorithmically determined based on the subset of goals selected by the user.

FIG. 6 shows an example of goal tracking reporting.

### DETAILED DESCRIPTION OF THE INVENTION

The presented invention provides structures, methods and techniques for tracking exercise level and energy consumption during pedestrian activities by accounting for: the step count, step length, speed and distance of a walk or a run. Our solution comprises of a range of algorithms for step count, movement classification, speed and distance determination, and energy consumption.

The proposed pedometer is designed to work with one or three orthogonal accelerometers. The acceleration signal is significantly distorted by user-dependent noise (time variant) and the gravity (time invariant). The user-dependent noise is associated with different body movement features such as: random and involuntarily tilting of the body to various degrees performed to provide the balance during movement, or personal characteristics of the movement, like the amplitude of the sideway tottering. Furthermore, the noise coming from the personal characteristics of the motion depends on the type of the activity, and for the same person may differ for walking and running. Variations in the noise are also influenced by different speeds of walking and running.

The static acceleration of gravity adds a time-invariant constant that offsets the mean value of the overall acceleration signal.

Due to the different types of noise impairing the original accelerometer signal, the raw accelerometer signal cannot provide the accurate evaluation of steps, motion classification, as well as speed and distance estimation, and hence needs to be processed. In this patent, the processing is accomplished by sub-band analysis filters, i.e., the set of the filters performing the spectral decomposition of the signal. The sub-band decomposition is the optimal solution in terms of the performance and complexity.

A filter bank is used to decompose the accelerometer signal into frequency sub-bands corresponding to the different ranges of speed and type of motion. The sub-band signals have different amplitudes and energy. The maximum amplitude and energy is associated with the sub-band for which the bandwidth corresponds to the spectral components of the accelerometer signal.

Assuming that the pedometer recognizes two types of motion (walk and run), the filter bank can consist of only two bands—the first covering the walk spectrum and the second the run spectrum. Therefore, for example, when the user walks then the signal with the maximum energy is on the output of the walk-band.

Further, a filter bank is also used to decompose signals into frequency bands corresponding to the different speed ranges. The zero crossing algorithm is applied for the step counting.

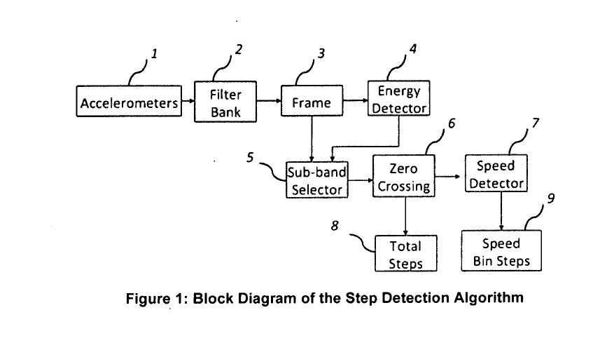

The block diagram of the pedometer is shown in FIG. 1. The pedometer uses an acceleration signal from the Accelerometers (1), which is then passed to the Filter Bank (2). Signals from the Filter Bank are stored in Frames (3). Based on the energy level evaluated by the Energy Detector (4), the relevant frame for the steps counting is selected by the Sub-band Selector (5). The signal then passes to the Zero Crossing Detector (6), and the number of steps in one frame is calculated. The total number of steps is stored in the Total Steps memory (8) by adding steps from all frames. The speed of motion related to the number of steps in one frame is classified by the Speed Selector (7) and subsequently stored in the appropriate speed range counter, referred to as Speed Bin Steps (9).

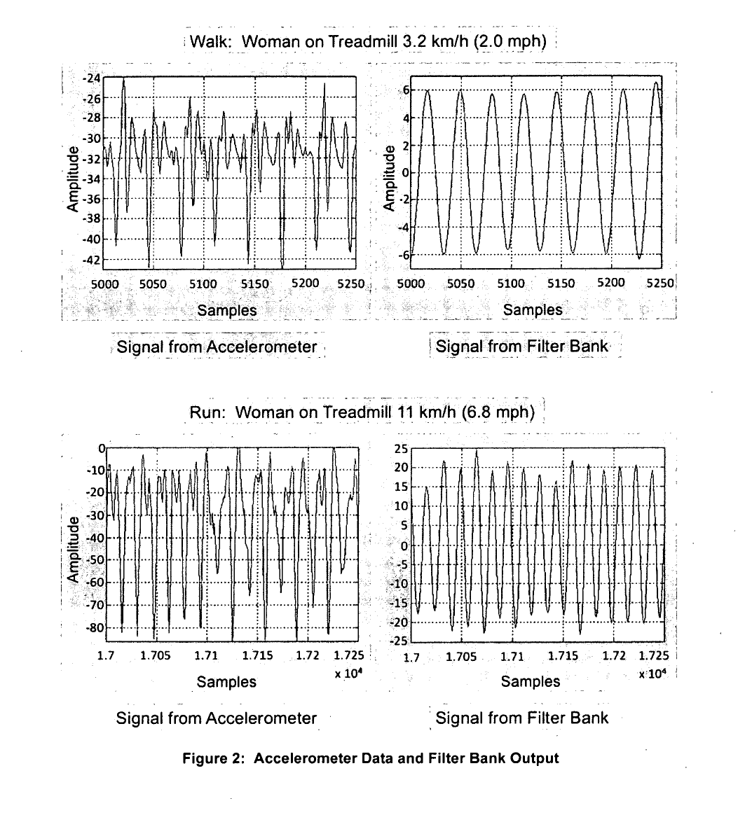

The filter bank for the sub-band decomposition is designed to eliminate the distortions of the acceleration signal and to provide a non-distorted sine wave signal capturing the motion of the user. Hence, the filter bank decomposes the accelerometer signal into different frequency bands corresponding to the different ranges of the speed. The non-distorted sine wave signal with the zero mean value appears on the output of this channel of the filter bank, for which the frequency bandwidth covers the spectral component for the particular speed, FIG. 2. Note that the frame energy is the biggest for this channel. Subsequently, the frame for the step counting is selected by the Sub-band Selector based on the energy level obtained by the Energy Detector. The signal from this channel passes to the Zero Crossing Detector.

FIG. 2 presents examples of raw accelerometer signals generated during walking and running on a treadmill performed by a female user. Associated with the accelerometer data are the sinusoidal signals from the filter bank selected by the Sub-band Selector.

The accelerometer signal is stored in the input frame, from where it is taken to the Filter Bank for processing. The sub-band filtering is performed in the frame.

The size of the frame equals to the user-selected reporting time of the steps count. The reporting time n can be chosen in the range: n=5 to 60 seconds. For n=5 s the speed changes are tracked fast, and the user obtains promptly the exact information about the number of steps, speed, type of motion and distance during the undergoing activity.

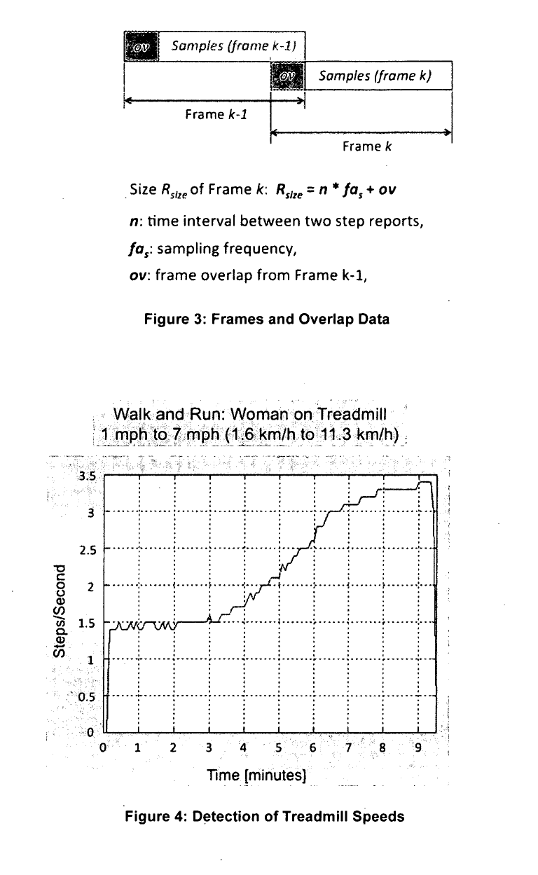

Consecutive frames overlap by the number of samples required for the filtering frame by frame, FIG. 3. The number of samples in the overlap is equal to the number of samples from the past when the first sample in the frame is filtered. For example, if the step count is reported every 5 s, then the frame size R_{size} is:

R_{size}=5*faₛ+ov,

where ov is the frame overlap, and faₛ is the sampling frequency.

The frame is organized as a circular buffer. The frame k starts from the sample located at position ov+1, and ends at the location R_{size}. The samples from 1 to ov are the last samples from the previous frame k−1 located in the range: R_{size}−(ov−1) to R_{size}, FIG. 3. The size of the overlap depends on the filter structure. For example, if it is an IIR filter organized as a cascade of the second order sections, then ov is equal to 2.

The linear phase is not essential in the presented algorithm and, in order to obtain the amplitude characteristic with a narrow transient band, the high-order IIR filters can be applied in the filter bank.

The pedometer algorithm proposed in this patent is characterized by a low computational complexity. In one implementation, the filters used in the sub-band decomposition are 6^{th}-order IIR filters with second order structure (SOS). These filters are optimally designed using N-step Newton method. The processing of one sample requires 15 multiplication and 16 additions per one filter (in total 31 real operations). Further, the zero-crossing method is also of low computational complexity.

The step detection is designed to provide the accurate results for individuals including children, adults, elderly, overweight and obese individuals. The zero crossing detection of the sine wave obtained from the filter bank does not depend on the amplitude level and its variation. Hence, for any user (child to elderly persons) and any speed, it gives the exact result.

The number of steps is one of the two elements for the distance evaluation. The second is the step length. The proposed way to account for the covered distance during the exercise regardless of the type of activity (walking, running) and personal traits (age, weight, height and gender) is to first obtain the baseline step (Step_Base) due to personal traits, and then adjust the step length based on the step rate and type of the activity. In particular, the number of steps and distance calculations account for step length dependency on the speed and type of walk/run, as well as the user's gender. In the literature, the baseline steps are given as [6], [7]:

Step_Base=0.42*height*0.01; for men

Step_Base=0.413*height*0.01; for women,

where height is reported in centimeters, and Step_Base in meters.

Additionally, in this application, the age correction age_correction factor has been introduced to the above equations to improve the accuracy of the step length for different age groups. The resulting Step_Base equations are:

Step_Base=0.42*height*0.01+age_correction; for men

Step_Base=0.413*height*0.01+age_correction; for women.

The values of age_correction were determined experimentally based on trials with children, women and men.

In addition to the baseline step length, the personal step length depends on the step rate and the type of the activity (walking or running) [5]. For determining the step length, the baseline step length Step_Base is therefore multiplied with the coefficient matrix SMult to account for the speed of motion. In SMult matrix, the first ten entries are multiplicands for speed bins corresponding to unit increments from 1 to 10 mph, while the last entry corresponds to all speeds exceeding 10 mph:

SMult=[0.875 0.90 0.975 1.08 1.175 1.275 1.375 1.475 1.55 1.6 1.625]. This results in the speed modified step length (Step_Length):

Step_Length(i)=Step_Base*SMult[i];

where i=1, . . . , 11.

The need for the SMult adjustment to the step length comes from the fact that the step length increases linearly with speed from the baseline step for a given individual[5]. Note that we modified the values of SMult proposed in literature. Based on experiments we determined the alternations in the gradient SMult of the increase of the step length with speed of motion to match the observed step lengths for different age groups, weight, heights and genders. The SMult matrix entrances are the same for users in all the age groups, heights, weights, and genders. Therefore, the actual difference in the step length for different users comes from the differences in their baseline step length.

The speed, of the activity is calculated for the exercise encountered in each frame. In particular, the speed is derived based on the number of steps in the frame (intensity of the movement) and the personal parameters such as height, age and gender. The Speed Detector, block (7) in FIG. 1 classifies the speed in the range from 1 mph to 10 mph plus there is one compartment covering speeds over 10 mph (US Units). The range increment is 1 mph. Alternatively, the speed scopes for standard metric system are reported in ranges from 1.5 km/h to 16.5 km/h with the base increment of 1.5 km/h, with the additional compartment for speeds exceeding 16.5 km/h. This speed range covers the walking and running activities from very low to very vigorous.

The classification of the speed from the Speed Detector is presented in FIG. 4. Reported is the motion in the range 1.5 mph to 7.8 mph with the step speed increase of 1 mph.

Finally, the Speed Detector determines the type of the activity (walking or running) based on the number of steps in the frame and the personal user parameters (height and gender). Note that the number of steps in the frame for the given speed decreases with the increase of the height of the user, and is greater for women than for men of the same height. Therefore, we introduced coefficients adjusting the number of steps in the frame to the speed for a given personal parameters. These coefficients were determined experimentally.

The number of steps taken in each frame, together with the corresponding speed and type of the activity (walking or running) is kept in the dedicated memory storage and is accessible to the user.

The total energy expenditure (Calₑₓₑ) is obtained for the walking/running motion for all ranges of speeds discussed in this patent. For each speed bin (range from 1 mph to 10 mph and greater than 10 mph), the algorithm calculates the energy expenditure Calₑₓₑ based on the BMR and the metabolic equivalent (MET) [3]. The energy expended during the running/walking for a particular speed is calculated in the following stages:
a) Energy BMR_{fm} expended by making the steps registered in one frame with the speed of motion established by the Speed Detector:

$${BMR}_{fm} = \frac{BMR}{( 24 \times 3600 / n )} \times {MET}_{i}$$

where n is the frame size in seconds. METᵢ, i=1, . . . , 11 is the coefficient of calories burned with a particular speed vᵢε[1 mph, . . . , 10 mph, block for speeds above 10 mph].
b) Energy BMR₁ₘᵢₙ expended in one minute of the physical activity is the sum of the BMR_{fm}(i), i=1, . . . , 60/n for frames lasting n seconds.
c) The total energy expenditure Calₑₓₑ of the physical activity is the accumulation of BMR₁ₘᵢₙ of the active minutes.

The ability of gathering and processing data by the pedometer during sports activities allows the user to pre-set complex exercise goals. For example, goals can be expressed as: steps+speed+type-of-motion, distance+speed+type-of-motion, duration or calories. Further, within a goal, the users can explicitly specify several intervals of varying steps+speed+type-of-motion or distance+speed+type-of-motion. For example, the goal can be set as: 1000 steps walk with speed of 3 mph; 2000 steps run with speed of 5 mph.

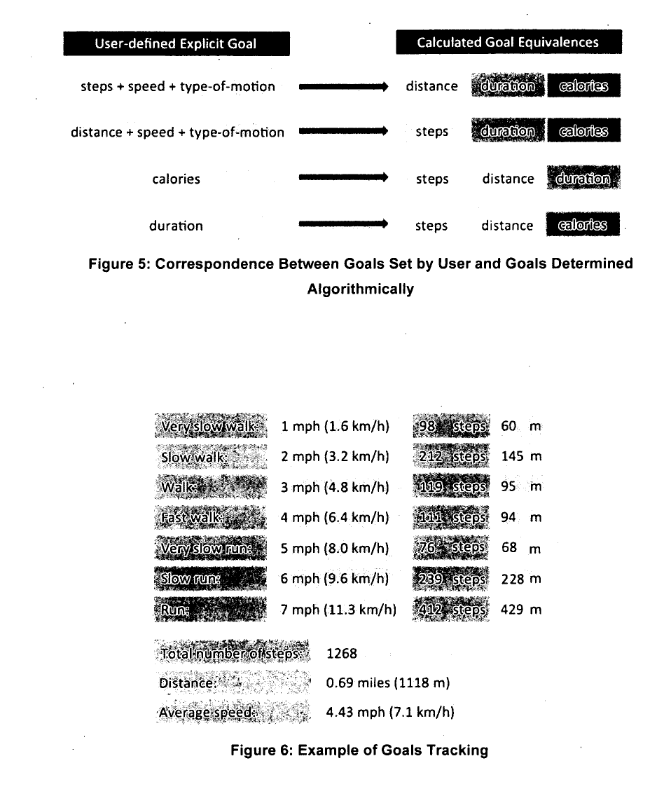

The complete setup of goals has the following features: steps, duration, speed, type of motion and calories. Even if the user selects only the subset of goals, then the pedometer calculates the setting values for the remaining goal features to provide the most complete picture of the exercise plan. FIG. 5 illustrates, which goal values are algorithmically determined based on the subset of goals set by the user. For example, if the user sets the goal in steps of particular type of motion (walk/run) and speed, he/she will be informed about the distance covered by the selected step count, as well as the energy expenditure of the goal. Note that the distance and calories determined algorithmically by the pedometer will depend not only on the above user chosen features, but also on the personal data such as age, gender, weight and height.

The goal execution is traced in real time with reporting every frame (5 s by default). However, to save energy for data processing, the user can select various modes of steps reporting: from automatic reporting in different regular intervals to updates on-demand upon refreshing the pedometer screen. An example of goal reporting is shown in FIG. 6, where the number of steps is reported for 7 different speeds, together with the distances for the given speeds as well as the total number of steps, distance and the average speed.

The goal is completed explicitly by reaching the user-selected goal. Further, for each user-set goal, the energy expenditure Cal_{goal} is determined algorithmically (implicitly). During the exercise, the energy expenditure Calₑₓₑ is calculated per each frame of the accelerometer data. If the accumulative calories burned Calₑₓₑ during the execution of the user-set goal match the algorithmically determined energy expenditure of the goal, Cal_{goal}, then the goal is marked as reached implicitly.

The algorithmic calculation of the energy expenditure Cal_{goal} of the user-set goal takes the following steps:
I. Determination of energy expenditure per minute of the goal exercise (BMR₁ₘᵢₙ) based on goal speed, type of motion and steps as:
   a. (BMR/1440)×MET
      i. User's energy expenditure at rest in 24 h;
      ii. 14440=# of minutes in 24 h;
      iii. MET—metabolic rate for a goal motion (walk/run) with goal speed;
II. Evaluation of the predicted duration of the goal exercise tₑₓₑ based on the explicit goal step count, as well as the motion type and speed;
II. Calculation of the total calorie expenditure Cal_{goal} of the exercise goal:
   a. Cal_{goal}=BMR₁ₘᵢₙ×tₑₓₑ
      i. BMR₁ₘᵢₙ—BMR of 1 min of goal exercise
      ii. tₑₓₑ—predicted duration of the goal exercise

Note that in the case when a user-set goal is composed of k activities of different step counts, types of motion and speeds, the overall BMR₁ₘᵢₙ is the sum of BR₁ₘᵢₙ per each activity BMR₁ₘᵢₙ (activity). Similarly, the time of the exercise is the sum of the durations of each activity tₑₓₑ (activity). Hence, Cal_{goal} for the overall goal is the sum of Cal_{goal} (activity) established for each activity.

In the case of user-set goals such as: steps+speed+type-of-motion or distance+speed+type-of-motion reaching the algorithmically calculated energy expenditure Cal_{goal} of these goals does not always translate to achieving explicitly these goals. For example, if the user chooses the goal to be: walking for 2000 steps with speed of 3 mph, and instead runs with the speed 5 mph, then, depending on user's personal data, the caloric representation Cal_{goal} of the goal will be reached after much fewer steps than goal setting. However, this method allows on completing the goal even if the speed during the exercises is not kept constant at the set values, but has some fluctuations.

Finally, the calories or time goals can be tracked only explicitly as set by the user.

### PATENT CITATIONS

U.S. Pat. No. 7,930,135B2 Dec. 23, 2008 Apr. 11, 2011. C-T. Ma, K-K. Chan, “Methods of distinguishing walking from running”.
US20130085677A1 Sep. 30, 2011. Y. Modi, V. B. Ganesh and S. Gupta “Techniques for improved pedometer readings”.

### OTHER REFERENCES

[1] G. Trapp, B. Giles-Corti, M. Bulsara, H. Christian, A. Timperio, G. McCormack and K. Villaneuva, “Measurement of Children's Physical Activity using a Pedometer with a Built-in Memory”, Journal of Science and Medicine in Sport, Vol. 16, No. 3, May 2013, pp. 222-226.
[2] C. Tudor-Locke, C. L. Craig, W. J. Brown, S. A. Clemens, K. de Cocker, B. Giles-Corti, Y. Hatano, S. Inoue, S. M. Matsudo, N. Mutrie, J. M. Oppert, D. A. Rowe, M. D. Schmidt, G. M. Schofled, J. C. Spencer, P. J. Teixeira, M. A. Tully, S. N. Blair, “How Many Steps/Day are Enough? For Adults”, Int Journal Behay. Nutr Phys Act., 8:79. Doi: 10.1186/1479-5868-8-79, Jul. 28 2011.
[3] B. E. Ainsworth, W. L. Haskell, S. D. Herrmann, N. Meckes, D. R. Bassett Jr, C. Tudor-Locke, J. L. Greer, J. Vezina, M. C. Whitt-Glover, A. S. Leon, “2011 Compendium of Physical Activities: a second update of codes and MET values”, Medicine and Science in Sports and Exercise, 2011; 43(8): 1575-1581.
[4] A. M. Roza and H. M. Shizgal, “The Harris-Benedict Equation Reevaluated: the Resting Energy Requirements and the Body Cell Mass”, American Journal of Clinical Nutrition, vol. 40, pp. 168-184, 1984.
[5] P. H. Sessoms, “Step by Step: A Study of Step Length in Able-bodied Persons, Race Walkers, and Persons with Amputation”, Ph.D. Dissertation, Northwestern University, 2008.
[6] http://www.ehow.com/how_{—}8294814_stride-length.html
[7] http://firstlibertykenya.blogspot.ca/2013_{—}07_{—}01_archive.html

1. A method for detecting steps, speed and distance of humans walking and running. The method: a) applies the sub-band analysis filtering of the accelerometer signal to obtain a non-distorted sine wave signal; b) detects the proper output band; c) performs the steps detecting by the zero-crossing algorithm. The proposed solution consists of:
I. Accelerometer sensors for detecting the movement;
II. Input frames (circular buffer) to store the accelerometer signal;
III. Filtering of acceleration data from the frame using the sub-band analysis filter bank resulting in the distortion-free sine wave signal;
a. Storing signals from each output of the filter bank in the output frames;
IV. The output frames energy detection for identifying the frame with the dominant energy that covers the spectral component for the current speed;
V. Step counting method based on the data in the frame selected by the energy detection:
a. The filtered signal that is selected for the steps counting is a non-distorted sine wave signal with a zero mean value;
VI. The zero-crossing algorithm for steps counting operating on the data in the frame selected by the energy detector.

2. A method for goal tracking. The energy expenditure is algorithmically determined for user-set goals of the type: steps with selected speed and type of motion (steps+speed+type_of_motion), or distance with selected speed and type of motion (distance+speed+type_of_motion). The energy expenditure for the above two types of goals is calculated as follows:
I. The number of steps, given selected speed, is converted into distance (applicable only for steps+speed+type_of_motion goal);
II. The duration (in minutes) of the exercise is determined given the speed and distance of the goal;
III. The energy expenditure of one minute of the goal exercise is calculated;
IV. Given the evaluated duration of the goal exercise (part II) and the energy expenditure of one minute of this exercise (part III), the overall energy cost of the goal exercise is determined.
Tracking the completion of the steps+speed+type_of_motion and distance+speed+type_of_motion goals is facilitated by monitoring the cumulative energy spent during the exercise, and comparing it to the algorithmically determined energy cost of these goals. The goals are declared completed if the goal settings are reached, or the cumulative energy expenditure of the exercise matches the algorithmically determined energy cost of these goals. This method allows on reaching the goal even if the speed of the motion differs in some intervals from the speed set up in the goals.

3. Hardware implementation of proposed pedometer algorithms. A device configured to implement the method of claim 1, wherein the pedometer is a standalone electronic device attached at various places in human body, including waist, hands, arms, legs and feet or within earphones.

4. Software implementation of proposed pedometer algorithms. An implementation the method of claim 1, wherein the pedometer is software executed on a Smartphone, tablet or similar devices.
